(19) United States
(12) Patent Application Publication
(10) Pub. No.: US 2007/0077193 A1
(43) Pub. Date: Apr. 5, 2007

(54) Method of using plasma to disintegrate an iron-compounded material to form ferric oxide

(76) Inventors: Te-Chu Chan, Taipei Hsien (TW); Chih-Chang Shen, Taipei (TW)

Correspondence Address: Rabin & Berdo, P.C., Suite 500, 1101 14th Street, Washington, DC, 20005, US

(21) Appl. No.: 11/240,523

(22) Filed: Oct. 3, 2005

(51) Int. Cl. C01G 49/06

(52) U.S. Cl. 423/633

(57) ABSTRACT

A method of using plasma to disintegrate an iron-compounded material to form ferric oxide (Fe₂O₃) has a reacting act and a heating act. The reacting act is reacting an iron-compounded acidic material with a basic material to generate a product of iron-compounded material. The heating act is heating the product with a high temperature plasma heating source until the product is disintegrated to form ferric oxide. The high temperature plasma effectively and quickly processes the iron-compounded material to form ferric oxide.

### BACKGROUND OF THE INVENTION

1. Field of the Invention

The present invention relates to a method of using plasma to neutralize iron compounds, and more particularly to a method of using plasma to disintegrate an iron-compounded material to form valuable ferric oxide (Fe₂O₃).

2. Description of the Related Art

Plasma is a highly ionized and high temperature gas. It is a combination of molecules, atoms, electrons and positive ions and is considered to be a “fourth state of matter” in addition to solid, liquid, and gas. High temperature plasma is a clean thermal-source that disintegrates large molecules without combustion.

The disintegration of waste is a process involving energy transmission and conversion. Compounds subjected to high temperature plasma disintegrate. The energy of the compounds in the plasma is transmitted to the waste through electric arcs in the high temperature plasma. When the waste and high temperature plasma interact, electrons in the molecules and atoms of the waste are stripped away from the nucleus of the atoms, breaking the bonds between the atoms of the waste compounds and fundamentally completely destroying the waste. Ideally, using high temperature plasma to break down waste only generates some simple molecules or atoms, such as hydrogen atoms, carbon oxide, carbon atoms, and hydrochloride, because the simple molecules or atoms cannot recombine into complex molecules in the high temperature plasma.

However, high temperature plasma has never been applied to process iron compounds.

To effectively process iron compounds, the present invention provides a method of using plasma to disintegrate an iron-compounded material to form ferric oxide (Fe₂O₃).

### SUMMARY OF THE INVENTION

The main objective of the invention is to provide a method that uses plasma to effectively disintegrate an iron-compounded material to form valuable ferric oxide (Fe₂O₃).

A method of using plasma to disintegrate an iron-compounded material to form ferric oxide (Fe₂O₃) in accordance with the present invention comprises a reacting act and a heating act.

The reacting act is reacting an iron-compounded acidic material with a basic material to generate a product of iron-compounded material.

The heating act is heating the product with a high temperature plasma heating source until the product is disintegrated to form ferric oxide.

Other objects, advantages and novel features of the invention will become more apparent from the following detailed description when taken in conjunction with the accompanying drawings.

### BRIEF DESCRIPTION OF THE DRAWINGS

FIGS. 1a, 1b, and 1c are diagrams showing the crystal structure of the Fe₂O₃ identified by the XRD after processing with the plasma for 2, 4 and 6 minutes, respectively. The vertical axis in each diagram represents the signal intensity and the horizontal axis represents the 2 θ;

FIGS. 2a, 2b and 2c are microphotographs showing the crystal structure of the Fe₂O₃ taken by the SEM after processing with the plasma for 2, 4 and 6 minutes, respectively; and

FIGS. 3a, 3b and 3c are spectrum analysis diagrams showing the energy distribution of the Fe₂O₃ as analyzed by the EDS after processing with the plasma for 2, 4 and 6 minutes, respectively.

### DETAILED DESCRIPTION OF PREFERRED EMBODIMENT

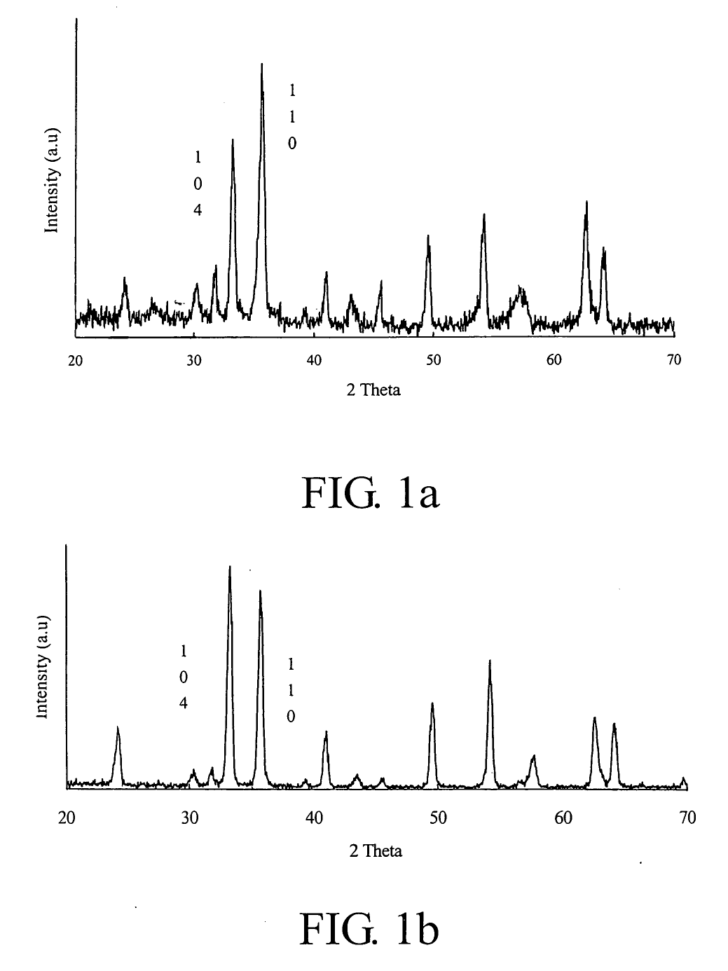

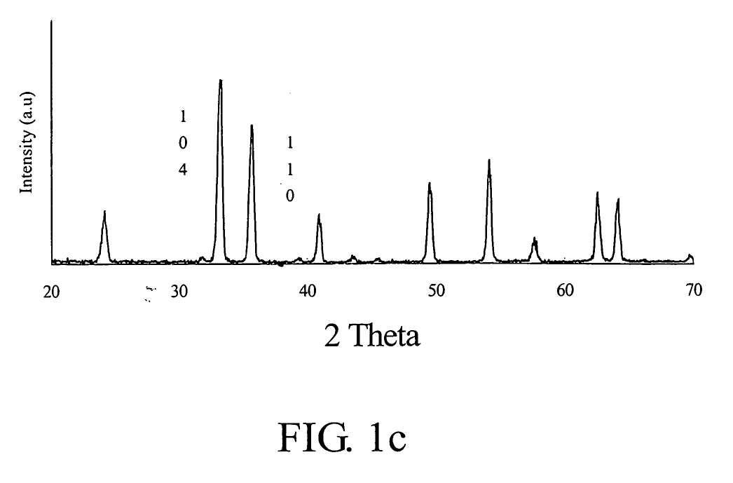

A method of using plasma to disintegrate an iron-compounded material to form ferric oxide (Fe₂O₃) in accordance with the present invention comprises a reacting act, a heating act and an optional analyzing act. The reacting act is reacting an iron-compounded acidic material with a basic material to generate a product. The heating act is heating the product with a high temperature plasma heating source until the product is disintegrated to form Fe₂O₃. The analyzing act is an analysis of a sample of the ferric oxide generated from the heating act and determining the quality of the ferric oxide. To further understand the method of using plasma to disintegrate an iron-compounded material to form ferric oxide (Fe₂O₃), an example follows with reference to FIGS. 1a-1c, 2a-2c and 3a-3c.

The reacting act of the method is reacting a sample of acidic material being ferrous chloride (FeCl₂) of 1 mole with a sample of basic material being sodium hydroxide (NaOH) of 2 mole. The reaction of the FeCl₂ and NaOH generates a product of iron hydroxide. The iron hydroxide is put in a cylindrical crucible having an open top with a diameter of 81 mm, a bottom with a diameter of 54 mm and a height of 99 mm.

The heating act is heating the product, iron hydroxide with a 15 kilowatt high temperature plasma heating source. The plasma heating source has a center with a temperature of at least 10,000° C. and provides heat to the iron hydroxide in the crucible in an air atmosphere. The flow rate of the air during the heating of the plasma is 4 kg/cm². The time of heating with the plasma may be 2, 4, or 6 minutes. The iron hydroxide heated by the plasma disintegrates to form crystal Fe₂O₃.

After treating the samples in the high temperature plasma, an analyzing act is performed on the crystal Fe₂O₃. The analyzing act is analyzing the Fe₂O₃ with an x-ray diffractometer (XRD, K αλ=1.5406 Å), a scanning electron microscopy (SEM) and an energy dispersive spectrometer (EDS). The XRD analyzes the Fe₂O₃ and identifies the crystal structure of the Fe₂O₃. The SEM takes a microphotograph of the Fe₂O₃. The EDS analyzes a spectrum of the Fe₂O₃ and identifies the composition of the Fe₂O₃.

The color of the Fe₂O₃ produced is deep brown, deep red, and red, when processed with the plasma for 2, 4 and 6 minutes, respectively.

With reference to FIGS. 1a, 1b, and 1c, the diagrams show the crystal structure of the Fe₂O₃ as identified by the XRD after processing with the plasma for 2, 4 and 6 minutes, respectively. The diagrams show that hematite exists in all of the products formed by the disintegration of the iron hydroxide after processing for 2, 4, and 6 minutes.

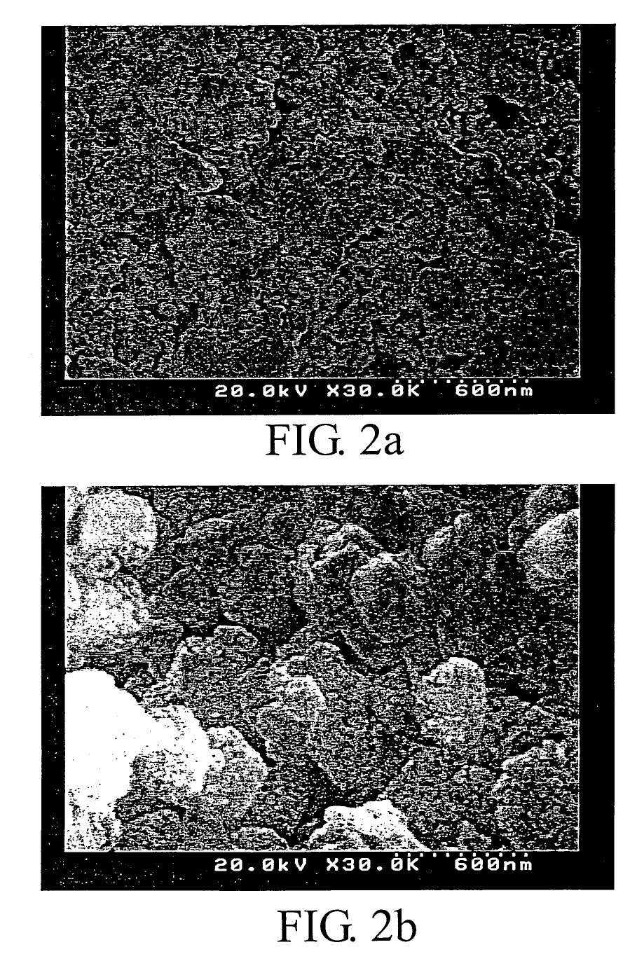

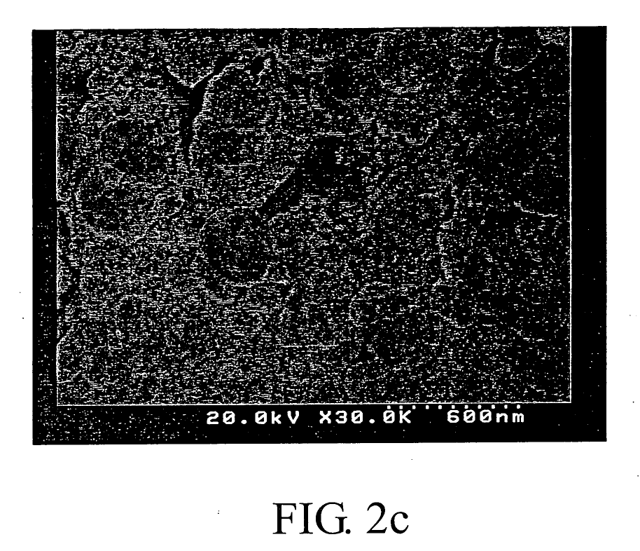

With reference to FIGS. 2a, 2b and 2c, the figures show the microphotographs taken by the SEM of the Fe₂O₃ formed after processing for 2, 4 and 6 minutes, respectively. The particle sizes in the crystal structure of the Fe₂O₃ formed are different for 2, 4 and 6 minutes of processing by the plasma.

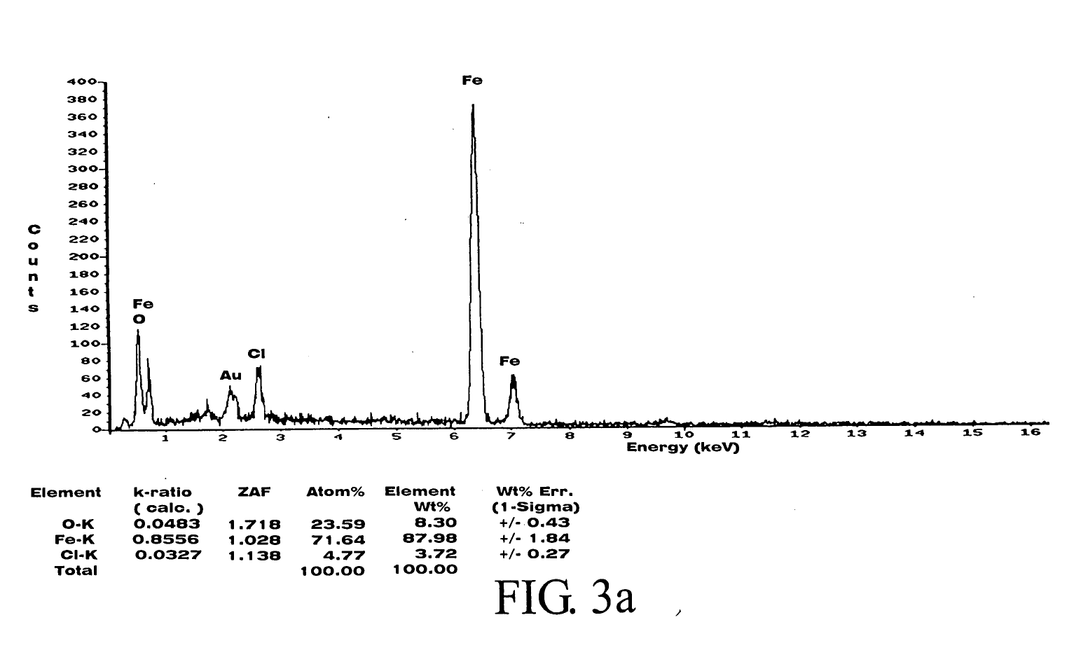

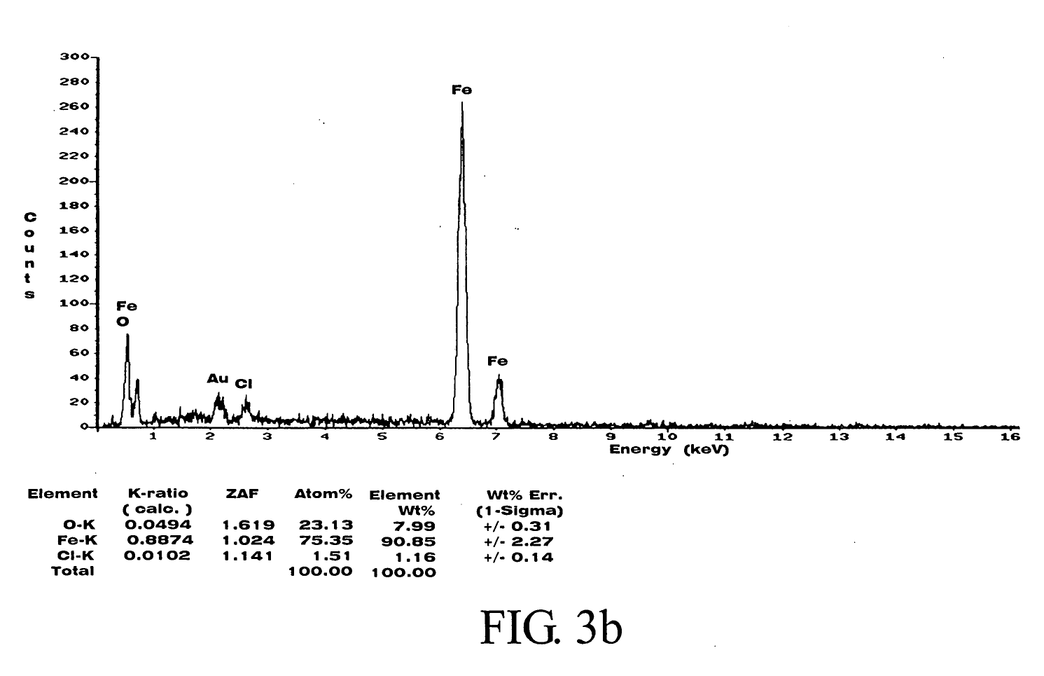

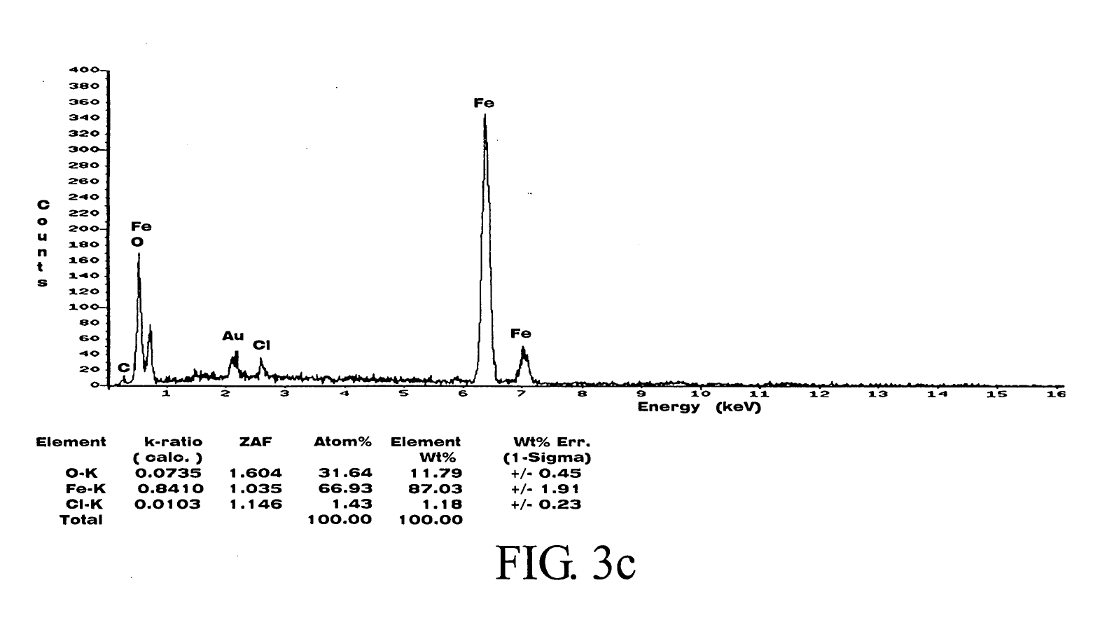

With reference to FIGS. 3a, 3b and 3c, the diagrams show the energy distribution of the Fe₂O₃ as analyzed by the EDS after processing for 2, 4 and 6 minutes, respectively. The diagrams show that the main components of the Fe₂O₃ are iron and oxygen.

Using high temperature plasma to treat waste is extremely safe, easily controlled and non-polluting. Moreover, the final products of high temperature plasma treatment are forms of Fe₂O₃, which is valuable. Several advantages of using high temperature plasma treatment are as follows:

1. High temperature plasma directly and effectively acts on the iron-compounded material so that loss of thermal energy is reduced.

2. The high temperature plasma efficiently removes and destroys organic material mixed in the iron-compounded material.

3. The high temperature plasma quickly processes the iron hydroxide so the method is time-saving.

Even though numerous characteristics and advantages of the present invention have been set forth in the foregoing description, together with details of the function of the invention, the disclosure is illustrative only. Changes may be made in the details, especially in matters of compositions of samples, within the principles of the invention to the full extent indicated by the broad general meaning of the terms in which the appended claims are expressed.

What is claimed is:

1. A method of using plasma to disintegrate an iron-compounded material to form ferric oxide (Fe₂O₃) comprising:
a reacting act being reacting an iron-compounded acidic material with a basic material to generate a product of iron-compounded material; and
a heating act being heating the product with a high temperature plasma heating source until the product is disintegrated to form ferric oxide.

2. The method as claimed in claim 1, wherein the plasma heating source has a center with a temperature of at least 10,000° C.

3. The method as claimed in claim 2, wherein the product of the iron-compounded acidic material reacting with the basic material is iron hydroxide.
